(19) United States
(12) Patent Application Publication
(10) Pub. No.: US 2021/0190600 A1
(43) Pub. Date: Jun. 24, 2021

(54) SWITCHING SYSTEM TEMPERATURE MEASUREMENT

(71) Applicant: SIEMENS AKTIENGESELLSCHAFT, MUENCHEN (DE)

(72) Inventor: THOMAS HINTZE, FALKENSEE (DE)

(21) Appl. No.: 17/268,666

(22) PCT Filed: Jul. 9, 2019
(86) PCT No.: PCT/EP2019/068410

§ 371 Date: Feb. 16, 2021

(30) Foreign Application Priority Data
Aug. 13, 2018 (DE) 10 2018 213 625.4

(51) Int. Cl. G01K 5/52; H01H 11/00

(52) U.S. Cl. CPC G01K 5/52; H01H 2011/0068; H01H 11/0062

(57) ABSTRACT

A switching system contains a switch for medium voltages and/or high voltages, wherein the switch has a first electrical connection on a first side of the switch, and a second electrical connection on a second side of the switch. A medium voltage or high voltage is supplied to the switch via the first electrical connection, and a medium voltage or high voltage is conducted away from the switch via the second electrical connection, or vice versa. A temperature measuring unit is provided. The temperature measuring unit has a temperature measuring head, a temperature transmission element, a temperature transmission medium, a temperature conversion element, and a temperature signaling device.

The invention relates to a switching station for medium voltages and/or high voltages with a temperature measurement, and to a method for operating a switching station with a temperature measurement.

In the prior art, temperature measurements in switching stations for medium voltages and/or high voltages at power terminals are known which are based on a contactless infrared temperature measurement or on a contacting measurement with radiofrequency sensors. A measurement with temperature measurement linked via cables by means of cable-bound temperature sensors is not possible in respect of current-carrying components, since voltages above 1000 V are present at power terminals and accordingly the requisite insulation resistances cannot be complied with. The simple utilization of contactless infrared thermometers is generally ruled out, since the power terminals to be examined have not been fitted in such a way that they are visually accessible at any time for an infrared temperature measurement. Radiofrequency sensors can only be positioned with difficulty and are also interchangeable only in very elaborate manner, so a temperature measurement in respect of power terminals of an installed system does not take place.

It is therefore an object of the invention to eliminate the disadvantages of the prior art and to provide an inexpensive, reliable temperature measurement that is easy to install.

The object is achieved by independent claim 1 and by the claims dependent thereon.

One embodiment relates to a switching station with a switch for medium voltages and/or high voltages, the switch being equipped with a first electrical connection on a first side of the switch and with a second electrical connection on a second side of the switch, a medium voltage or high voltage being supplied to the switch via the first electrical connection, and a medium voltage or high voltage being conducted away from the switch via the second electrical connection, or conversely, and with a temperature-measuring unit, the temperature-measuring unit exhibiting a temperature-measuring head, a temperature-transmitting element, a temperature-transmitting medium, a temperature-transducing element and a temperature-signaling device, wherein:
the temperature-measuring head is arranged on the first electrical connection or on the second electrical connection,
the temperature-transmitting element adjoins the temperature-measuring head, the temperature-measuring head being configured to be heat-conducting in such a manner that it assumes a first temperature of the first electrical connection or of the second electrical connection or approaches this first temperature, and the temperature-measuring head being configured to transmit the first temperature to the temperature-transmitting medium arranged in the temperature-transmitting element in such a manner that said temperature-transmitting medium assumes a volume, and hence a length, that is characteristic of the first temperature, the temperature-transmitting element and the temperature-transmitting medium being designed to be electrically insulating, and the temperature-transmitting element and the temperature-transmitting medium having different coefficients of thermal expansion,
the characteristic volume of the temperature-transmitting medium acts on the temperature-transducing element in such a manner that the temperature-transducing element generates a temperature signal which is indicated, signaled and/or stored by the temperature-signaling device.

It is preferred that the temperature-transmitting element has a coefficient of thermal expansion that is negligibly small in comparison with the coefficient of thermal expansion of the temperature-transmitting medium.

It is also preferred that the temperature-transducing element contains a barometric cell and/or a piezoelectric switch and/or a pressure sensor and/or displacement detector.

Furthermore, it is preferred that the temperature-signaling device exhibits an analog temperature display and/or a digital temperature display.

It is also preferred that the temperature-signaling device exhibits a digital temperature display and that the temperature-signaling device processes the temperature signal or passes it on, unprocessed, to a memory unit and/or a communication unit.

It is also preferred that the communication unit is configured to pass on the processed or unprocessed temperature signal to one or more centralized or distributed computers. In particular, it is preferred that the processed or unprocessed temperature signal is stored in a cloud application and processed further. Furthermore, it is particularly preferred that the cloud application determines a state of the switching station—in particular, a maintenance state or loading state—on the basis of the processed or unprocessed temperature signal of one or more switching stations—in particular, of several switching stations not communicating with one another—and when one or more threshold values is/are exceeded a warning signal or a control signal is sent, in particular a warning signal is sent to a control center and/or a control signal is sent to a control center and/or to the switching station in question exceeding the threshold value.

Furthermore, it is preferred that the switch in the switching station takes the form of a vacuum switch.

It is also preferred that the switch takes the form of a hermetically sealed gas-insulated switch in a gas-insulated switching station, the temperature-measuring head is located in a gas tank filled with an insulating gas, and the temperature-transmitting element with the temperature-transmitting medium is guided out of the gas tank through a bushing, the temperature-transmitting element with the temperature-transmitting medium being arranged in the bushing in gas-tight manner.

It is also preferred that the temperature-transmitting element with the temperature-transmitting medium is arranged in the bushing in such a manner that a transmission of mechanical stresses from the bushing to the temperature-transmitting element with the temperature-transmitting medium is minimized.

Furthermore, it is preferred that the temperature-transmitting element with the temperature-transmitting medium exhibits a metal lip, preferably a curved or corrugated metal lip, which minimizes a transmission of mechanical stresses from the bushing to the temperature-transmitting element with the temperature-transmitting medium.

It is also preferred that the one or more centralized or distributed computers analyze the processed or unprocessed temperature signal with respect to a temperature criterion and emit a warning signal to a control room when a fixed or variable threshold value for the temperature criterion is exceeded, and/or initiate a shutdown of the switching station when a further fixed or variable threshold value for the temperature criterion is exceeded. In particular, it is preferred that the processed or unprocessed temperature signal is stored in a cloud application and processed further. Furthermore, it is particularly preferred that the cloud application determines a state of the switching station—in particular, a maintenance state or loading state—on the basis of the processed or unprocessed temperature signal of one or more switching stations—in particular, of several switching stations not communicating with one another—and when one or more threshold values is/are exceeded a warning signal or a control signal is sent, in particular a warning signal is sent to a control center and/or a control signal is sent to a control center and/or to the switching station in question exceeding the threshold value.

The invention will be elucidated in the following by way of example with reference to figures.

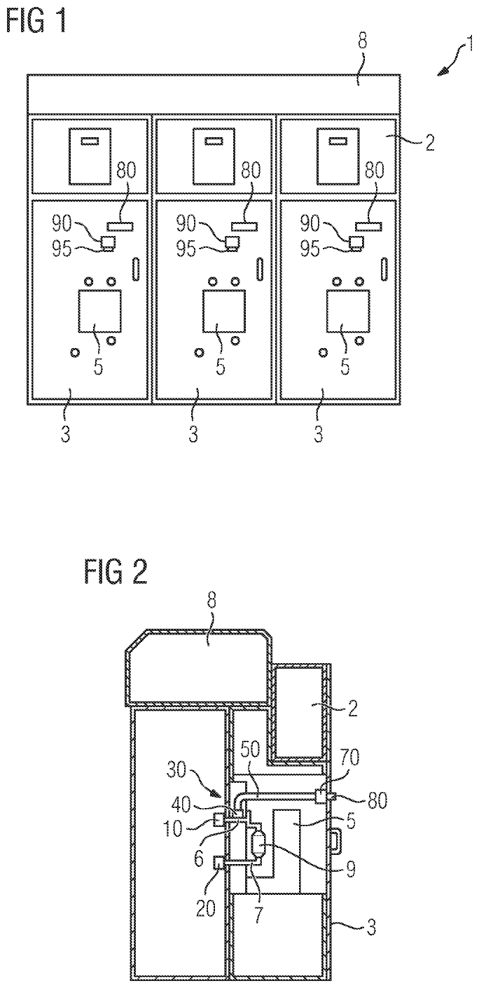

FIG. 1: schematic representation of a front view of a switching station according to the invention;

FIG. 2: schematic representation of a side view of a switching station according to the invention with partial elevation in the region of a vacuum switch;

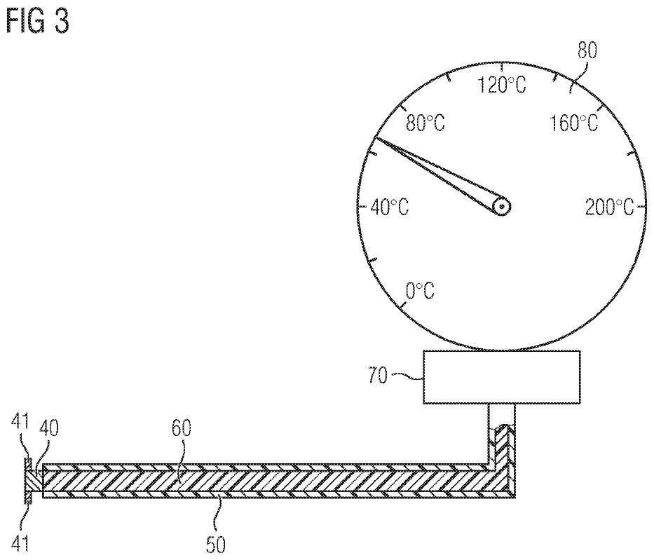

FIG. 3: schematic representation of a temperature-measuring unit for a switching station according to the invention;

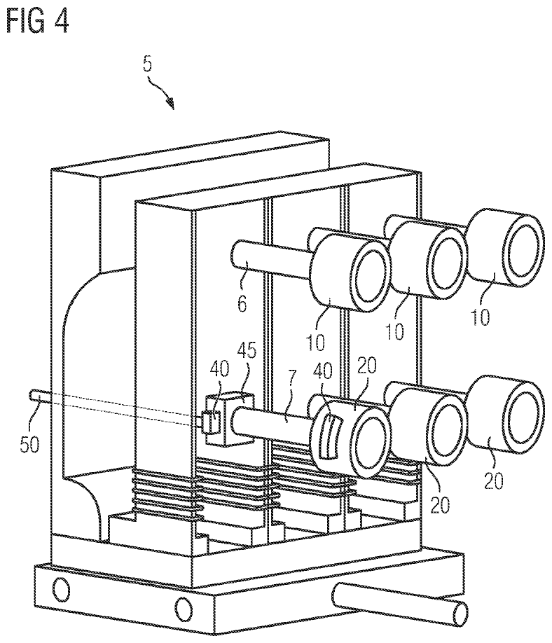

FIG. 4: schematic representation of a retractable switch with a temperature-measuring unit for a switching station according to the invention.

FIG. 1 shows a schematic representation of a front view of a switching station 1 according to the invention.

The switching station 1 according to the invention here consists, by way of example, of three power-switching units which are equipped with a common pressure-relief duct 8. Each of the three power-switching units is equipped with a door 3 in front of a compartment with a vacuum switch 5 for medium voltages and/or high voltages. Alternatively, but not shown here, instead of the vacuum switch it may also be a question of a gas-insulated switch. A low-voltage compartment 2 is arranged above the compartment for the vacuum switch 5. In the door 3 a recess has been provided here by way of example, through which it is possible for operating elements of the vacuum switch 5 to be accessed. In or on the door 3 there is also a temperature-signaling device 80; in particular, the latter may have been fastened to the vacuum switch 5 and made visible through a second recess or a window through the door. Likewise, a memory unit 90 and/or a communication unit 95 may optionally have been arranged on, behind or in the door 3. Alternatively, a memory unit 90 and/or a communication unit 95 may also have been arranged at other locations in the switching station and may have been connected in wire-bound and/or wireless manner to a temperature-measuring unit 30 which is only hinted at here and not indicated.

FIG. 2 shows a schematic representation of a side view of a switching station 1 according to the invention with partial elevation in the region of a vacuum switch 5 with vacuum interrupter 9. It is preferred that the switching station 1 is of single-pole or three-pole design and one or more vacuum interrupters 9 are assigned to each pole. As shown in FIG. 1, the common pressure-relief duct 8, the low-voltage compartment 2 and the door 3 are also represented in FIG. 2.

In the region of the vacuum switch 5 a part of the side paneling has been removed, in order to make it possible for the vacuum switch 5 with the temperature-measuring unit 30 to be seen.

The temperature-measuring unit 30 is equipped with a temperature-measuring head 40, a temperature-transmitting element 50 with a temperature-transmitting medium 60 shown in FIG. 3, a temperature-transducing element 70 and a temperature-signaling device 80, which here has been guided through the door 3. The temperature-measuring head 40 in this example is arranged on a first electrical connection 10 on a first side 6 of the vacuum switch 5. Alternatively, the temperature-measuring head 40 may also have been arranged on a second side 7 on a second electrical connection 20. The temperature-measuring head 40 is connected to the temperature-transducing element 70 via the temperature-transmitting element 50. The temperature-transducing element 70 is, in turn, attached to the temperature-signaling device 80. In the example shown, the vacuum switch 5 is arranged on an extensible platform in the switching station 1 and exhibits contact tulips. Alternatively, the vacuum switch 5 may also have been fixedly mounted in the switching station 1.

FIG. 3 shows a schematic representation of a temperature-measuring unit 30 for a switching station 1 according to the invention, for instance from FIGS. 1 and 2. The temperature-measuring unit 30 exhibits a temperature-measuring head 40 which here can optionally be fastened at the measuring location with two temperature-measuring-head fastening means 41. The temperature-measuring-head fastening means 41 may be, for instance, openings for screws, screws, sleeves or clip-type guides. The temperature-measuring head 40 is configured in such a way that it is able to assume a temperature at a measuring location and pass it on to a temperature-transmitting medium 60, the temperature-transmitting medium 60 being arranged in a temperature-transmitting element 50. The temperature-transmitting medium 60 and the temperature-transmitting element 50 preferably have different coefficients of thermal expansion, so that a heating or cooling of the temperature-transmitting medium 60 and of the temperature-transmitting element 50 leads to a differing expansion in volume, and hence to a differing linear expansion, of the temperature-transmitting medium 60 and of the temperature-transmitting element 50. By virtue of the differing expansion in volume, and hence differing linear expansion, of the temperature-transmitting medium 60 and the temperature-transmitting element 50, the pressure changes on the temperature-transducing element 70 which passes on the registered change in pressure mechanically, hydraulically, magnetically or electrically to the temperature-signaling device 80, represented here in analog form. In order to be able to guarantee the requirements relating to the safety of switching stations, the temperature-transmitting medium 60 and the temperature-transmitting element 50 are designed to be electrically non-conducting.

FIG. 4 shows a schematic representation of a retractable, three-pole vacuum switch 5 with a temperature-measuring unit 30 for a switching station 1 according to the invention. In this example, the temperature-measuring head 40 is arranged on a second electrical connection 20 on a second side 7 of the vacuum switch 5 and is represented, by way of example only, on a pole of the vacuum switch 5. The region framed by dashed lines permits a view, through the casing, of the heat-dissipating means 45 with the temperature-measuring head 40 and the temperature-transmitting element 50.

Alternatively, the temperature-measuring head 40 may also have been arranged on a first side 6 on a first electrical connection 10. As a further alternative, a temperature-measuring head 40 is also shown on a retractable tulip, this time without a temperature-transmitting element 50.

### LIST OF REFERENCE SYMBOLS

1 switching station;
2 low-voltage compartment;
3 door in front of a vacuum switch for medium voltages and/or high voltages;
5 switch for medium voltages and/or high voltages;
6 first side of the switch (5);
7 second side of the switch (5);
8 pressure-relief duct;
9 vacuum interrupter;
10 first electrical connection;
20 second electrical connection;
30 temperature-measuring unit;
40 temperature-measuring head;
41 temperature-measuring-head fastening means;
45 heat-dissipating means;
50 temperature-transmitting element;
60 temperature-transmitting medium;
70 temperature-transducing element;
80 temperature-signaling device;
90 memory unit;
95 communication unit.

1-11. (canceled)

12. A switching station, comprising:
a switch for medium voltages and/or high voltages, said switch having a first electrical connection on a first side of said switch and a second electrical connection on a second side of said switch, a medium voltage or a high voltage being supplied to said switch via said first electrical connection, the medium voltage or the high voltage being conducted away from said switch via said second electrical connection; and
a temperature-measuring unit having a temperature-measuring head, a temperature-transmitting element, a temperature-transmitting medium, a temperature-transducing element and a temperature-signaling device, wherein:
said temperature-measuring head is disposed on said first electrical connection or on said second electrical connection;
said temperature-transmitting element adjoining said temperature-measuring head, said temperature-measuring head being configured to be heat-conducting in such a manner that it assumes a first temperature of said first electrical connection or of said second electrical connection or approaches the first temperature, said temperature-measuring head being configured to transmit the first temperature to said temperature-transmitting medium disposed in said temperature-transmitting element in such a manner that said temperature-transmitting medium assumes a volume that is characteristic of the first temperature, said temperature-transmitting element and said temperature-transmitting medium being configured to be electrically insulating, and said temperature-transmitting element and said temperature-transmitting medium having different coefficients of thermal expansion; and
a characteristic volume of said temperature-transmitting medium acting on said temperature-transducing element in such a manner that said temperature-transducing element generates a temperature signal being indicated, signaled and/or stored by said temperature-signaling device.

13. The switching station according to claim 12, wherein said temperature-transmitting element has a negligibly small coefficient of thermal expansion in comparison with a coefficient of thermal expansion of said temperature-transmitting medium.

14. The switching station according to claim 12, wherein said temperature-transducing element contains a barometric cell and/or a piezoelectric switch and/or a pressure sensor.

15. The switching station according to claim 12, wherein said temperature-signaling device has an analog temperature display and/or a digital temperature display.

16. The switching station according to claim 15, wherein:
said temperature-measuring unit has a memory and a communication unit; and
said temperature-signaling device has a digital temperature display and in that said temperature-signaling device passes on the temperature signal, processed or unprocessed, to said memory and/or said communication unit.

17. The switching station according to claim 16, wherein said communication unit is configured to pass on the temperature signal, processed or unprocessed, to at least one centralized or distributed computer.

18. The switching station according to claim 12, wherein said switch is a vacuum switch.

19. The switching station according to claim 12,
wherein said switch is a hermetically sealed gas-insulated switch;
further comprising a bushing; and
further comprising a gas tank, said temperature-measuring head is disposed in said gas tank filled with an insulating gas, and said temperature-transmitting element with said temperature-transmitting medium is guided out of said gas tank through said bushing, said temperature-transmitting element with said temperature-transmitting medium being disposed in said bushing in a gastight manner.

20. The switching station according to claim 19, wherein said temperature-transmitting element with said temperature-transmitting medium is disposed in said bushing in such a manner that a transmission of mechanical stresses from said bushing to said temperature-transmitting element with said temperature-transmitting medium is minimized.

21. The switching station according to claim 20, wherein for a purpose of attachment to said temperature-transmitting element with said temperature-transmitting medium said bushing has a metal lip which minimizes the transmission of mechanical stresses from said bushing to said temperature-transmitting element with said temperature-transmitting medium.

22. The switching station according to claim 21, wherein said metal lip is a curved or corrugated metal lip.

23. A method for operating a switching station having a switch for medium voltages and/or high voltages, the switch having a first electrical connection on a first side of the switch and a second electrical connection on a second side of the switch, a medium voltage or a high voltage being supplied to the switch via the first electrical connection, and the medium voltage or the high voltage being conducted away from the switch via the second electrical connection, the switching station further containing a temperature-measuring unit having a temperature-measuring head, a temperature-transmitting element, a temperature-transmitting medium, a temperature-transducing element and a temperature-signaling device,
which comprises the steps of:
analyzing, via at least one centralized or distributed computer, a processed or unprocessed temperature signal with respect to a temperature criterion; and
emitting a warning signal to a control room when a fixed or variable threshold value for the temperature criterion is exceeded, and/or initiate a shutdown of the switching station when a further fixed or variable threshold value for the temperature criterion is exceeded.
